(19) United States
(12) Patent Application Publication
(10) Pub. No.: US 2011/0074275 A1
(43) Pub. Date: Mar. 31, 2011

(54) DISPLAY DEVICE HAVING GAS INPUT BARRIER

(75) Inventor: Joo-Hoon LEE, Yongin-si (KR)

(73) Assignee: Samsung Electronics Co., Ltd., Suwoni-si (KR)

(21) Appl. No.: 12/893,667

(22) Filed: Sep. 29, 2010

(30) Foreign Application Priority Data
Sep. 29, 2009 (KR) 10-2009-0092479

(51) Int. Cl. H01J 5/02

(52) U.S. Cl. 313/317

(57) ABSTRACT

Disclosed is a display device having a gas input barrier, which encapsulates a gas barrier layer through lamination and blocks the input of outside gas (moisture, water, oxygen, and the like) through further compression. The disclosed display device includes first and second gas barrier layers provided with an adhesive layer; a first gas input barrier provided at a lateral side of the first and second gas barrier layers to encapsulate the first and second gas barrier layers through lamination, and to block input of outside gas; and a second gas input barrier which is further compressed on the first gas input barrier by using a compression jig, and blocks an input path of the outside gas into the first gas input barrier.

### PRIORITY

This application claims priority under 35 U.S.C. §119(a) to a Korean Patent Application filed with the Korean Intellectual Property Office on Sep. 29, 2009 and assigned Serial No. 10-2009-0092479, the contents of which are incorporated herein by reference.

### BACKGROUND OF THE INVENTION

1. Field of the Invention

The present invention generally relates to a display device having a gas input barrier, and in particular, to a display device that encapsulates a gas barrier layer through lamination and blocks the input of outside gas (moisture, water, oxygen, and the like) through further compression.

2. Description of the Related Art

Generally, a next generation flexible display may representatively include an electronic paper display, and a self-luminous Organic Light Emitting Diode (OLED) display. The electronic paper display may include various types of displays, and the most representative example of which is an electrophoretic electronic paper display.

An electrophoretic display is a device which employs movement of charged particles caused by an electric field applied between electrodes, and may be applied to a display for an electronic book, an electronic newspaper, an electronic magazine, and a portable communication device.

Electrophoresis means the movement of charged particles when an electric field is applied. When the electrophoresis occurs in a fluid, the charged particles are moved at a velocity determined by viscous drag, charge, the fluid's dielectric properties, and the magnitude of applied electric field.

Colors of such an electrophoretic display device are determined by particles having one or more colors, dispersed within dielectric fluids with different colors. In other words, when particles having one or more colors are applied with an electric field, the charged particles having opposite charges move toward electrodes having polarities opposite to those of the electric field. As a result, the change in colors can be visually observed.

As shown in FIG. 1, an electrophoretic display device 10 includes a display cell 20, which includes a transparent or opaque lower electrode substrate 21, a digital ink part 22, a transparent upper electrode 23, and a transparent substrate 24. The digital ink part 22 includes particles having at least one color, on the upper portion of the lower electrode substrate 21, and the transparent upper electrode 23 is provided to the upper portion of the digital ink part.

A transparent Organic Light Emitting Display (OLED) device has a structure including an OLED layered on a Thin Film Transistor (TFT) layer forming an electric circuit, in which a light emitting layer of the OLED selectively emits light according to the signal controlled through the TFT layer (not shown).

However, in order to produce the electrophoretic display device and the transparent OLED device, the development of a high-quality thin film passivation layer for the reliability of the electrophoretic display device must be accomplished. The reliability of the eletrophoretic display device is directly linked with the life of the device. Most organic electronic devices using an organic compound (such as an electrode layer, a digital ink, an organic TFT layer, and an OLED) are subject to decomposition because they are very sensitive to moisture, oxygen, water, light, and the like, existing in the air. Furthermore, since they have poor durability in heat, an increase in temperature reduces their life.

Accordingly, the electrophoretic display device and the transparent OLED device require a gas barrier which can block the input of gas in the air, such as moisture, water, and oxygen.

In general, such displays whose properties are damaged by oxygen or moisture, employ a glass substrate with a very low gas permeation rate, as a lower electrode substrate and an upper transparent substrate to form upper and lower gas barriers. However, in a case where a display requires flexibility, a rigid glass substrate cannot be used, and thus, a gas barrier must either be deposited to a plastic substrate, or an additional gas barrier film is laminated and sealed on the display. As shown in FIG. 1, the display cell 20 includes gas barrier film layers 30 and 40 laminated and sealed at the upper and lower portions thereof.

In this state, at the outer portion of the gas barrier film layers 30 and 40, an adhesion portion 50 is provided which is for blocking outside gas such as due to humidity, moisture, water, oxygen, and the like.

In the electrophoretic display device 10 as shown in FIG. 1, the inflow path of outside gas A1 such as moisture, water, oxygen, and the like, is as follows.

In general, the outside gases A1 flow in through the gas barrier film layers 30 and 40. Otherwise, the gases flow in through the adhesion portion 50 at the outer portion of the gas barrier film layers 30 and 40.

As shown in FIG. 1, the gas barrier film layers 30 and 40 show a very low gas permeability to the outside gases A1 passed therethrough, while the adhesion portion 50 of the gas barrier film layers 30 and 40 shows a high gas permeability several times higher than the gas barrier film layers 30 and 40 to the gases passed therethrough.

Therefore, in inhibiting the input of the outside gas A1, the adhesion portion 50 formed at the lateral side of the gas barrier film layers 30 and 40 is very important. Thus, the adhesion portion 50 has to employ an adhesive with a low gas permeability, and have a long length so as to lengthen the input path of the gas.

However, in a conventional electrophoretic display device, when the length of an adhesion portion is lengthened, the size of a display panel is increased with respect to a fixed utilization area. This results in a reduction of commercial quality.

Therefore, there is a need for an electrophoretic display device which has an adhesion portion with a minimized length, formed at the outer lateral side of a gas barrier film layer, and can inhibit permeation of outside gases.

### SUMMARY OF THE INVENTION

Accordingly, the present invention has been made to solve the above-mentioned problems occurring in the prior art, and the present invention provides a display device having a gas input barrier, which encapsulates a gas barrier layer through lamination and blocks the input of outside gas (moisture, water, oxygen, and the like) through further compression. Accordingly, it is possible to reduce the thickness and length of a product, and improve a gas barrier characteristic of the product by narrowing the input path of the outside gas.

Also, the present invention provides a display device having a gas input barrier, in which the gas input barrier blocks the input of outside gas while an uneven portion is formed at the lateral side of a gas barrier layer through further compression. Accordingly, the uneven portion scatters the input path of the outside gas in multiple directions, thereby delaying the input time of the gas. This improves the gas barrier's effectiveness. For this reason, the display device incorporating the present invention can be used for a long time with improved reliability.

Further, the present invention provides a display device having a gas input barrier, wherein the gas input barrier encapsulates an upper substrate (a glass substrate or a transparent substrate), and a gas barrier layer of the display device through lamination, and blocks the input of outside gas through further compression. Herein, the upper substrate of the display device has characteristics of a gas barrier. This further reduces the thickness of a product, and does not additionally require a gas barrier layer, thereby reducing the number of components. Accordingly, it is possible to reduce the production cost of the product and improve the assembly process.

Moreover, the present invention provides a display device having a gas input barrier, wherein the gas input barrier encapsulates a lower substrate (a glass substrate or a lower electrode substrate), and a gas barrier layer of the display device through lamination, and blocks the input of outside gas through further compression. Herein, the lower substrate of the display device has characteristics of a gas barrier. This further reduces the thickness of a product, and does not additionally require a gas barrier layer, thereby reducing the number of components. Accordingly, it is possible to reduce the production cost of the product and improve the assembly process.

In accordance with an aspect of the present invention, there is provided a display device with a gas input barrier, including first and second gas barrier layers provided with an adhesive layer; a first gas input barrier provided at a lateral side of the first and second gas barrier layers to encapsulate the first and second gas barrier layers through lamination, and to block the input of outside gas; and a second gas input barrier which is further compressed on the first gas input barrier by using a compression jig, and blocks an input path of the outside gas into the first gas input barrier.

In accordance with another aspect of the present invention, there is provided a display device with a gas input barrier, including an upper substrate provided with an adhesive layer; a gas barrier layer provided with an adhesive layer; a first gas input barrier provided at a lateral side of the upper substrate and the gas barrier layer to encapsulate the upper substrate and the gas barrier layer through lamination, and to block the input of outside gas; and a second gas input barrier which is further compressed toward the gas barrier layer of the first gas input barrier by using a compression jig, and blocks an input path of the outside gas into the first gas input barrier.

In accordance with a further aspect of the present invention, there is provided a display device with a gas input barrier, including a lower substrate provided with an adhesive layer; a gas barrier layer provided with an adhesive layer; a first gas input barrier provided at a lateral side of the lower substrate and the gas barrier layer to encapsulate the lower substrate and the gas barrier layer through lamination, and to block the input of outside gas; and a second gas input barrier which is further compressed toward the gas barrier layer of the first gas input barrier by using a compression jig, and blocks an input path of the outside gas into the first gas input barrier.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a side cross-sectional view illustrating the configuration of a conventional electrophoretic display device;

FIG. 2 is an exploded perspective view illustrating the configuration of a display device provided with a gas input barrier according to a first embodiment of the present invention;

FIG. 3 is a side cross-sectional view illustrating a process of forming a first gas input barrier through lamination, in the configuration of a display device provided with a gas input barrier according to the first embodiment of the present invention;

FIG. 4 is a plan view illustrating the configuration of a display device provided with a gas input barrier according to the first embodiment of the present invention;

FIG. 5 is a side cross-sectional view illustrating a process of forming a second gas input barrier, in the configuration of a display device provided with a gas input barrier according to the first embodiment of the present invention;

FIG. 6 is an enlarged side cross-sectional view illustrating A of FIG. 5;

FIG. 7 is a plan view illustrating an input path of outside gas in a display device provided with a gas input barrier according to the first embodiment of the present invention;

FIG. 8 is an enlarged side cross-sectional view illustrating another embodiment of a second gas input barrier, in the configuration of a display device provided with a gas input barrier according to the first embodiment of the present invention;

FIG. 9 is an enlarged side cross-sectional view illustrating B of FIG. 8;

FIG. 10 is an exploded perspective view illustrating the configuration of a display device provided with a gas input barrier according to a second embodiment of the present invention;

FIG. 11 is a side cross-sectional view illustrating a process of forming a first gas input barrier through lamination of an upper substrate and a gas barrier layer, in the configuration of a display device provided with a gas input barrier according to the second embodiment of the present invention;

FIG. 12 is a plan view illustrating the configuration of a display device provided with a gas input barrier according to the second embodiment of the present invention;

FIG. 13 is a side cross-sectional view illustrating a process of forming a second gas input barrier, in the configuration of a display device provided with a gas input barrier according to the second embodiment of the present invention;

FIG. 14 is an enlarged side cross-sectional view illustrating C of FIG. 13;

FIG. 15 is a plan view illustrating an input path of outside gas in a display device provided with a gas input barrier according to the second embodiment of the present invention;

FIG. 16 is an enlarged side cross-sectional view illustrating another embodiment of a second gas input barrier, in the configuration of a display device provided with a gas input barrier according to the second embodiment of the present invention;

FIG. 17 is an enlarged side cross-sectional view illustrating D of FIG. 16;

FIG. 18 is an exploded perspective view illustrating the configuration of a display device provided with a gas input barrier according to a third embodiment of the present invention;

FIG. 19 is a side cross-sectional view illustrating a process of forming a first gas input barrier through lamination of a lower substrate and a gas barrier layer, in the configuration of a display device provided with a gas input barrier according to the third embodiment of the present invention;

FIG. 20 is a plan view illustrating the configuration of a display device provided with a gas input barrier according to the third embodiment of the present invention;

FIG. 21 is a side cross-sectional view illustrating a process of forming a second gas input barrier, in the configuration of a display device provided with a gas input barrier according to the third embodiment of the present invention;

FIG. 22 is an enlarged side cross-sectional view illustrating E of FIG. 21;

FIG. 23 is a plan view illustrating an input path of outside gas in a display device provided with a gas input barrier according to the third embodiment of the present invention;

FIG. 24 is an enlarged side cross-sectional view illustrating another embodiment of a second gas input barrier, in the configuration of a display device provided with a gas input barrier according to the third exemplary of the present invention; and

FIG. 25 is an enlarged side cross-sectional view illustrating F of FIG. 24.

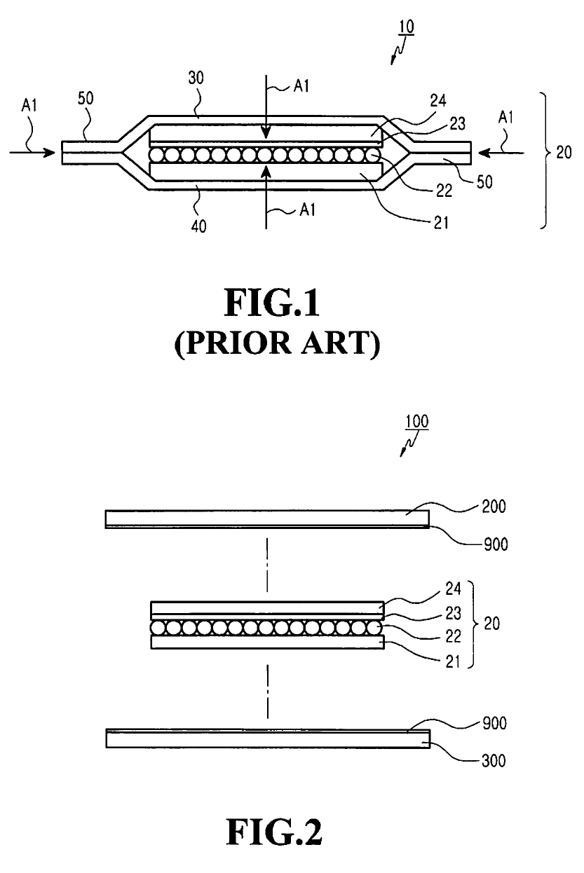

### DETAILED DESCRIPTION OF THE EMBODIMENTS OF THE PRESENT INVENTION

Hereinafter, preferred embodiments of the present invention will be described in detail with reference to the accompanying drawings. It should be understood, however, that the accompanying drawings and embodiments are explanatory only, and the invention is to cover all modifications, equivalents, and alternatives falling within the scope of the present invention as defined by the appended claims.

As shown in FIGS. 2 to 7, a display device 100 provided with a gas input barrier includes first and second gas barrier layers 200 and 300, respectively, each provided with an adhesion layer 900, and first and second gas input barriers 500 and 600, respectively. The first and second gas barrier layers 200 and 300 are provided at the upper and lower portions, respectively, of a display cell 20 in such a manner that they can cover the display cell 20 of the display device 100, and are encapsulated and sealed through lamination. The first gas input barrier 500 is provided at the lateral side of the first and second gas barrier layers 200 and 300 in such a manner that it can encapsulate the first and second gas barrier layers 200 and 300 through lamination, and block the input of outside gas A1 into the first and second gas barrier layers 200 and 300. The second gas input barrier 600 is further compressed by a compression jig 800 and is provided in the first gas input barrier 500 in such a manner that it can secondarily block the input path of the outside gas A1 into the first gas input barrier 500.

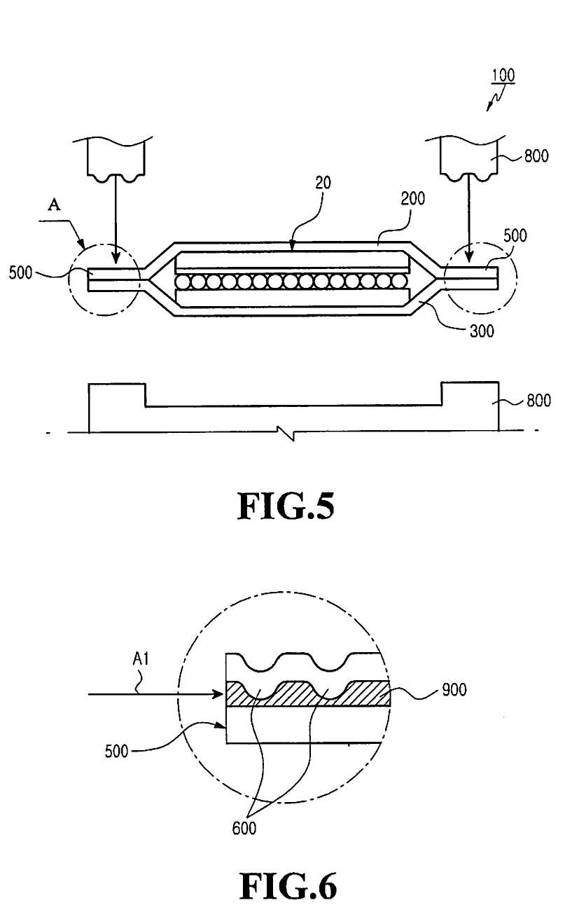

As shown in FIGS. 5 to 7, the compression jig includes an uneven jig 800, the second gas input barrier 600 includes multiple uneven portions formed by the uneven jig 800, the uneven portions of the second gas input barrier 600 include multiple embossed projections, and the embossed projections are not aligned.

The second gas input barrier 600 is formed in any one of a curved-line pattern, an oblique line pattern, a net pattern, and a zigzag pattern, and may be formed in other patterns besides the above mentioned patterns.

The outside gas A1 includes at least one of moisture, water, and oxygen, and may include other outside gases besides moisture, water, and oxygen.

As shown in FIGS. 5 to 7, the second gas input barrier 600 is configured to cause the outside gas A1 input to the first gas input barrier 500 the collide against the uneven portions of the second gas input barrier 600. This scatters the input path of the outside gas A1 in multiple directions, and delays the input time of the outside gas A1.

The first and second gas barrier layers 200 and 300 include transparent or semi-transparent gas barrier film layers.

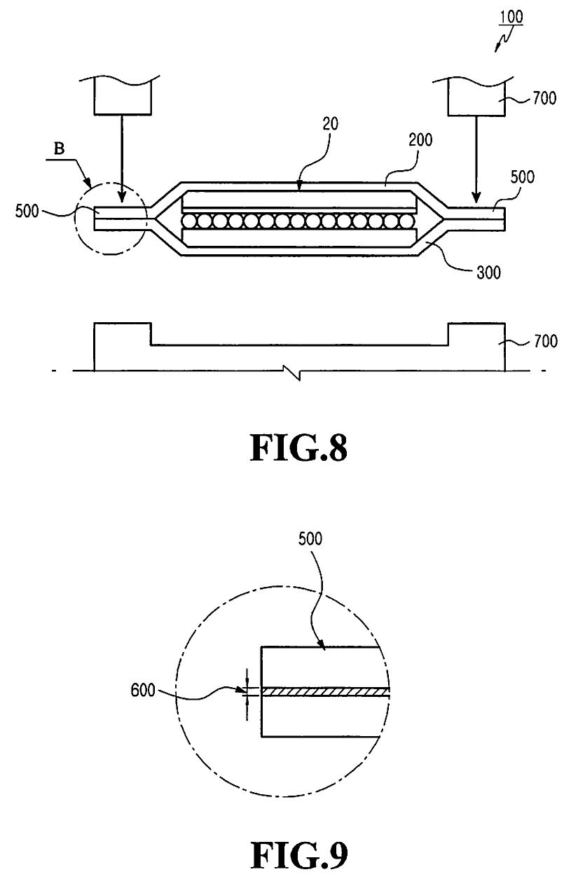

FIGS. 8 and 9 show another embodiment of the second gas input barrier 600, in which the second gas input barrier 600 is compressed through a flat compression jig 700, and has a thickness less than that of the first gas input barrier 500.

Also, the second gas input barrier 600 may be compressed by another compression jig than the above mentioned uneven jig such as the flat compression jig 700 of FIG. 8, and may be further compressed by an additional compression jig.

Hereinafter, the operation process of the display device having the gas input barrier with the above described configuration, according to a first preferred exemplary embodiment of the present invention, will be described in detail with reference to the accompanying drawings 2 to 9.

As shown in FIGS. 2 to 9, the display device 100 provided with the gas input barrier includes the display cell 20 of the display device, the first and second gas barrier layers 200 and 300 provided with the adhesion layer 900, and the first and second gas input barriers 500 and 600.

As shown in FIG. 2, the display cell 20 includes a transparent or opaque lower electrode substrate 21, a digital ink part 22, a transparent upper electrode 23, and a transparent substrate 24. The digital ink part 22 includes particles having at least one color, on the upper portion of the lower electrode substrate 21, and the transparent upper electrode 23 is provided to the upper portion of the digital ink part 22.

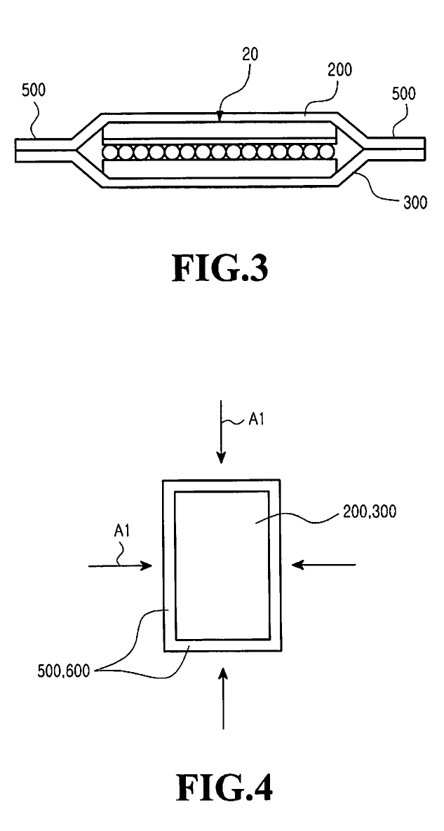

As shown in FIG. 3, the first and second gas barrier layers 200 and 300 are provided at the upper and lower portions of the display cell 20 in such a manner that they can cover the display cell 20, and are encapsulated and sealed through lamination.

As shown in FIGS. 3 and 4, at the lateral side of the first and second gas barrier layers 200 and 300, the first gas input barrier 500 is formed, which encapsulates the first and second gas barrier layers 200 and 300 through lamination, and blocks the input of the outside gas A1.

In this state, as shown in FIGS. 5 and 6, the first gas input barrier 500 is further compressed by the compression jig 800 while the second gas input barrier 600 is formed. The compression jig 800 preferably includes an uneven jig.

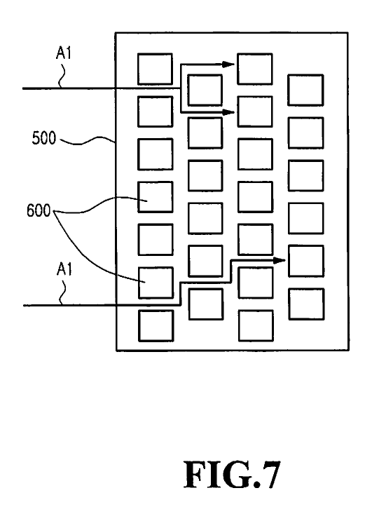

As shown in FIG. 7, the second gas input barrier 600 includes multiple uneven portions formed by the uneven jig 800, the uneven portions of the second gas input barrier 600 include multiple embossed projections, wherein the embossed projections are not aligned. In this state, the second gas input barrier 600 may further block the outside gas A1.

Herein, as shown in FIG. 7, when the outside gas A1 is input into the second gas input barrier 600, the outside gas A1 collides with and comes in contact with the uneven portions of the second gas input barrier 600. The uneven portions of the second gas input barrier 600 change the direction of the input path of the outside gas A1, thus scattering the outside gas A1 and inhibiting contamination of water or oxygen in the display device 100.

As described above, the outside gas A1 is not input in a straight path but collides with the uneven portions of the second gas input barrier 600. This scatters the input path of the outside gas A1 in vertical/horizontal directions, thereby delaying the input time of the outside gas A1.

Also, in a case where the uneven portions of the second gas input barrier 600 are formed in any one of a curved-line pattern, an oblique line pattern, a net pattern, and a zigzag pattern, the path of the outside gas A1 is changed or the outside gas A1 is scattered, according to the patterned shape of the uneven portions.

Also, in another embodiment of the second gas input barrier 600 shown in FIGS. 8 and 9, the second gas input barrier 600 is formed by compressing the first gas input barrier 500 through a flat compression jig 700, and has a thickness smaller than that of the first gas input barrier 500. This preferably narrows the input path of the outside gas A1.

Accordingly, the second gas input barrier 600 having a thin thickness delays the input time of the input outside gas A1.

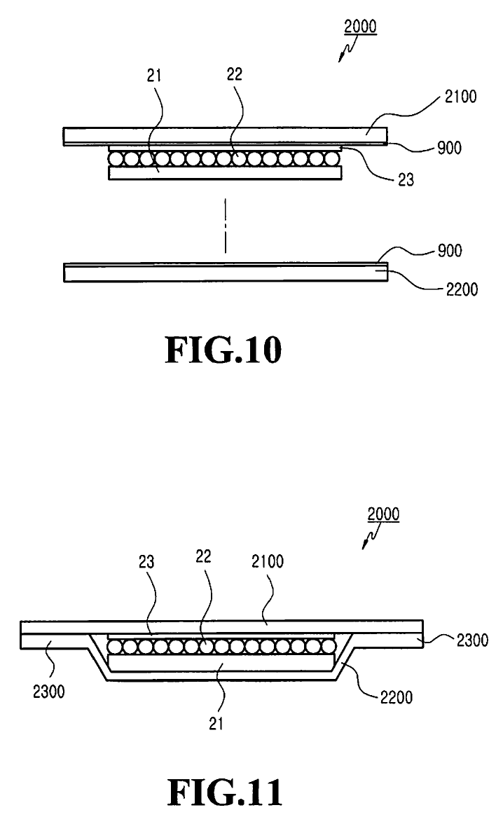

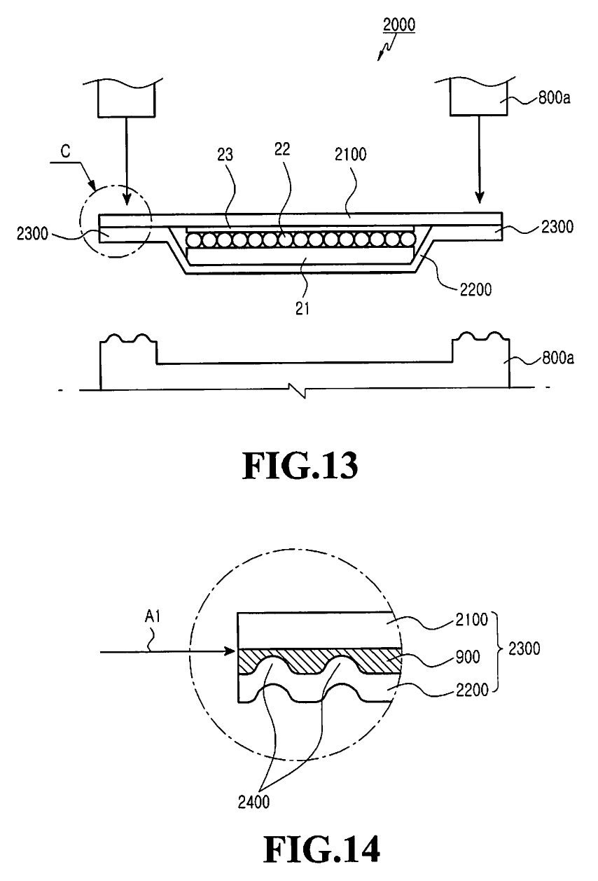

Hereinafter, an operation process of the display device having the gas input barrier with the above described configuration, according to a second preferred embodiment of the present invention, will be described in detail with reference to the accompanying FIGS. 10 to 17.

As shown in FIGS. 10 to 15, a display device 2000 provided with the gas input barrier includes a lower electrode substrate 21 of the display device, a digital ink part 22, a transparent upper electrode 23, an upper substrate 2100 provided with an adhesive layer 900, a gas barrier layer 2200 provided with the adhesive layer 900, and first and second gas input barriers 2300 and 2400, respectively. The upper substrate 2100 includes a glass substrate or a transparent substrate.

As shown in FIGS. 10 and 11, the upper substrate 2100 extends farther than the lower electrode substrate 21. Herein, the gas barrier layer 2200 and the upper substrate 2100 are encapsulated and sealed through lamination.

Herein, the lower electrode substrate 21, the digital ink part 22, and the transparent upper electrode 23 are also sealed.

As shown in FIGS. 10 and 11, the first gas input barrier 2300 is provided at the lateral side of the upper substrate 2100 and the gas barrier layer 2200, which can encapsulate the gas barrier layer through the lamination, and block the input of outside gas A1.

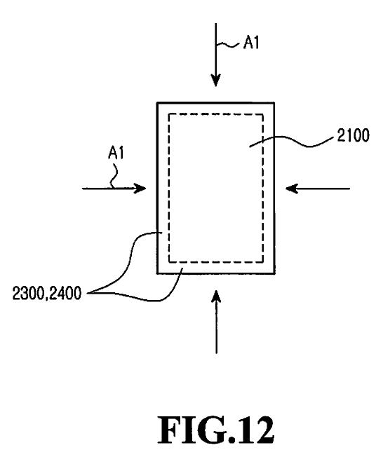

Herein, as shown in FIGS. 12 to 14, a compression jig 800a is used to further compress toward the gas barrier layer 2200 of the first gas input barrier 2300 while the second gas input barrier 2400 is formed. The compression jig 800a includes an uneven jig.

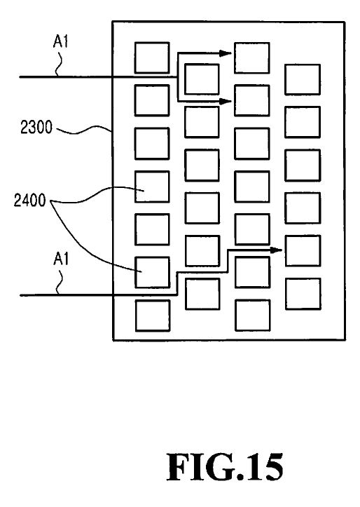

As shown in FIG. 15, the second gas input barrier 2400 includes multiple uneven portions formed by the uneven jig, the uneven portions of the second gas input barrier 2400 include multiple embossed projections, and the embossed projections are not aligned. In this state, the second gas input barrier 2400 may further block the outside gas A1.

Herein, as shown in FIG. 15, when the outside gas A1 is input into the second gas input barrier 2400, the outside gas A1 collides with and comes in contact with the uneven portions of the second gas input barrier 2400. The uneven portions of the second gas input barrier 2400 change the direction of the input path of the outside gas A1, thus scattering the outside gas A1 and inhibiting contamination of water or oxygen in the display device 2000.

As described above, the outside gas A1 is not input in a straight path but collides with the uneven portions of the second gas input barrier 2400. This scatters the input path of the outside gas A1 in vertical/horizontal directions, thereby delaying the input time of the outside gas A1.

Also, in a case where the uneven portions of the second gas input barrier 2400 are formed in any one of a curved-line pattern, an oblique line pattern, a net pattern, and a zigzag pattern, the path of the outside gas A1 is changed or the outside gas A1 is scattered, according to the patterned shape of the uneven portions.

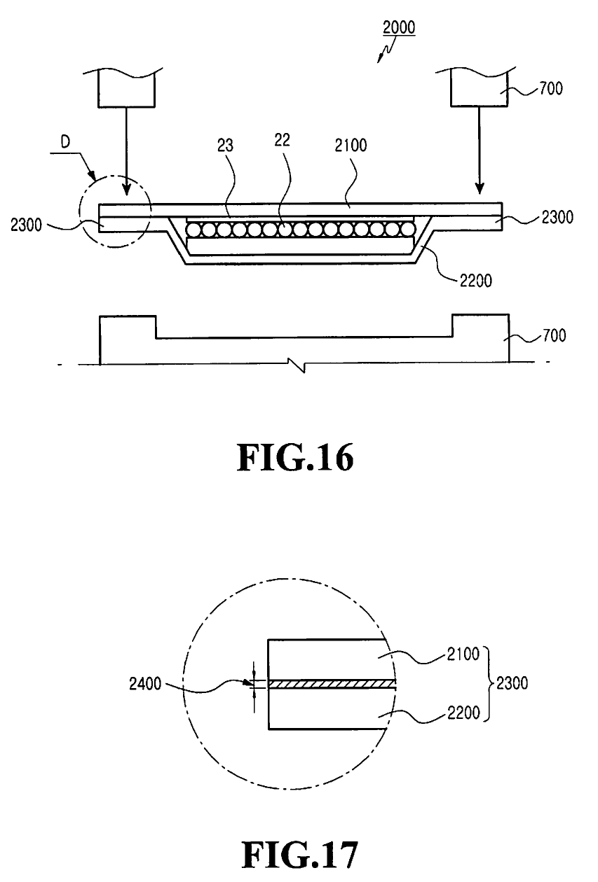

In another embodiment of the second gas input barrier 2400 shown in FIGS. 16 and 17, another compression jig 700 may compress toward the gas barrier layer 2200 of the first gas input barrier 2300 while the second gas input barrier 2400 has a thickness less than that of the first gas input barrier 2300. This may narrow the input path of the outside gas A1. Accordingly, the second gas input barrier 2400 having a thin thickness may delay the input time of the input outside gas A1.

As described above, the upper substrate 2100 not only includes a glass substrate or a transparent substrate but also acts as a gas barrier. The use of the upper substrate 2100 as a transparent substrate of a display device further reduces the thickness of a product, and does not additionally require the gas barrier layer 2200, thereby reducing the number of components. This may reduce the production cost of the product and improve the assembly process.

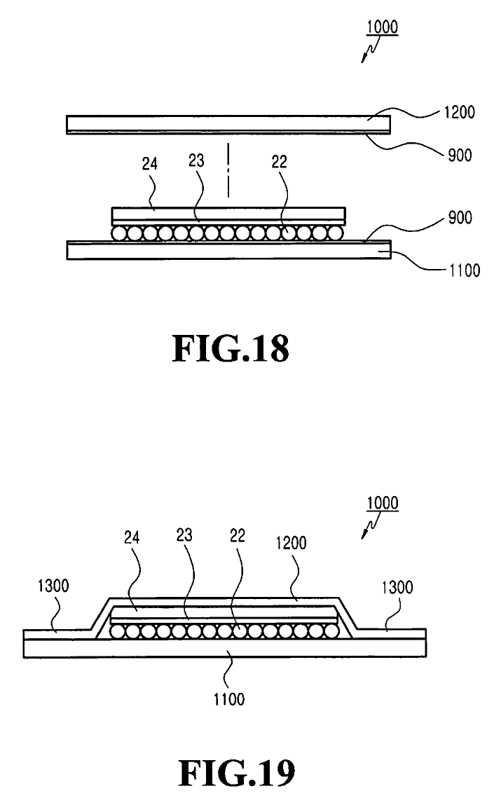

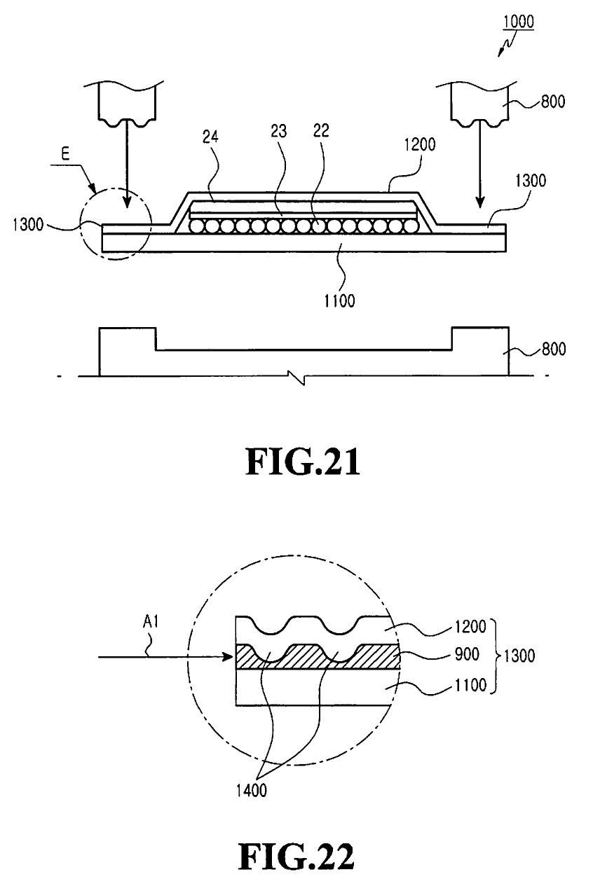

Hereinafter, an operation process of the display device having the gas input barrier with the above described configuration, according to a third preferred embodiment of the present invention, will be described in detail with reference to the accompanying FIGS. 18 to 25.

As shown in FIGS. 18 to 23, a display device 1000 provided with the gas input barrier includes a digital ink part 22 of the display device, a transparent upper electrode 23, a transparent substrate 24, a lower substrate 1100 provided with an adhesive layer 900, a gas barrier layer 1200 provided with the adhesive layer 900, and first and second gas input barriers 1300 and 1400, respectively. The lower substrate 1100 includes a glass substrate or a lower electrode substrate.

As shown in FIGS. 18 and 19, the lower substrate 1100 extends farther than the transparent substrate 24. Herein, the gas barrier layer 1200 and the lower substrate 1100 are encapsulated and sealed through lamination.

Herein, the transparent substrate 24, the digital ink part 22, and the transparent upper electrode 23 are also sealed.

As shown in FIG. 19, the first gas input barrier 1300 is provided at the lateral side of the lower substrate 1100 and the gas barrier layer 1200, which can encapsulate the gas barrier layer through the lamination, and block the input of outside gas A1.

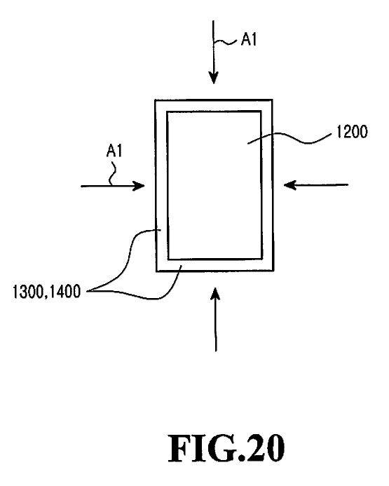

Herein, as shown in FIGS. 20 to 22, a compression jig 800 is used to further compress toward the gas barrier layer 1200 of the first gas input barrier 1300 while the second gas input barrier 1400 is formed. The compression jig 800 includes an uneven jig.

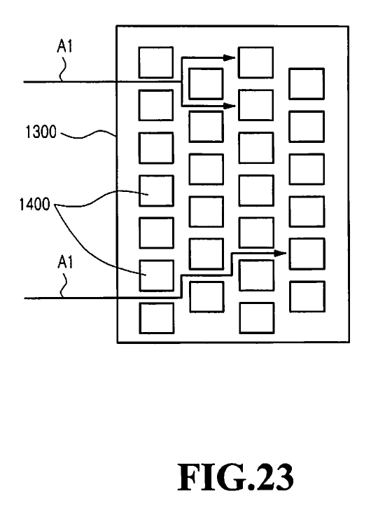

As shown in FIG. 23, the second gas input barrier 1400 includes multiple uneven portions formed by the uneven jig, the uneven portions of the second gas input barrier 1400 include multiple embossed projections, and the embossed projections are not aligned. In this state, the second gas input barrier 1400 may further block the outside gas A1.

Herein, as shown in FIG. 23, when the outside gas A1 is input into the second gas input barrier 1400, the outside gas A1 collides with and comes in contact with the uneven portions 1400. Then, the uneven portions change the direction of the input path of the outside gas A1 or scatter the outside gas A1.

As described above, the outside gas A1 is not input in a straight path but collides with the uneven portions of the second gas input barrier 1400. This scatters the input path in vertical/horizontal directions, thereby delaying the input time of the outside gas A1.

Also, in a case where the uneven portions of the second gas input barrier 1400 are formed in any one of a curved-line pattern, an oblique line pattern, a net pattern, and a zigzag pattern, the path of the outside gas A1 is changed or the outside gas A1 is scattered, according to the patterned shape of the uneven portions.

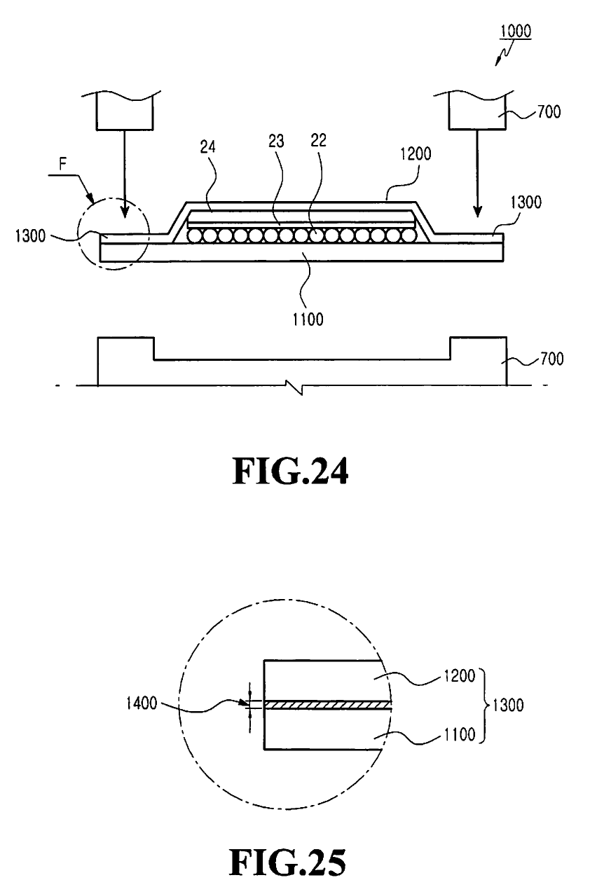

Also, in another embodiment of the second gas input barrier 1400 shown in FIGS. 24 and 25, another compression jig 700 may compress toward the gas barrier layer 1200 of the first gas input barrier 1300 while the second gas input barrier 1400 has a thickness less than that of the first gas input barrier 1300. This may narrow the input path of the outside gas A1. Accordingly, the second gas input barrier 1400 having a thin thickness may delay the input time of the input outside gas A1.

As described above, the lower substrate 1100 not only includes a glass substrate or a lower electrode substrate but also acts as a gas barrier. The use of the lower substrate 1100 as a lower electrode substrate of a display device further reduces the thickness of a product, and does not additionally require the gas barrier layer 1200, thereby reducing the number of components. This may reduce the production cost of the product and improve the assembly process.

In the above description, an electrophoretic display device according to embodiments of the present invention is representatively shown. However, the display device of the present invention is not limited to the electrophoretic display device, and may be applied to various types of display devices, e.g. a transparent OLED device, and an application device thereof.

The display device provided with the gas input barrier, according to the present invention, as described above, is not limited by the above described exemplary embodiments and drawings. While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A display device provided with a gas input barrier, comprising:
first and second gas barrier layers provided with an adhesive layer;
a first gas input barrier provided at a lateral side of the first and second gas barrier layers to encapsulate the first and second gas barrier layers through lamination, and to block input of outside gas; and
a second gas input barrier which is further compressed on the first gas input barrier using a compression jig, and which blocks an input path of outside gas into the first gas input barrier.

2. The display device provided with the gas input barrier as claimed in claim 1, wherein the compression jig comprises an uneven jig.

3. The display device provided with the gas input barrier as claimed in claim 2, wherein the second gas input barrier comprises multiple uneven portions made by the uneven jig, the uneven portions comprise multiple embossed projections, and the embossed projections are not aligned.

4. The display device provided with the gas input barrier as claimed in claim 1, wherein the second gas input barrier comprises any one of a curved line pattern, an oblique line pattern, a net pattern, and a zigzag pattern.

5. The display device provided with the gas input barrier as claimed in claim 1, wherein the outside gas comprises at least one of moisture, water, oxygen, and the like.

6. The display device provided with the gas input barrier as claimed in claim 1, wherein the second gas input barrier causes the outside gas input into the first gas input barrier to collide with uneven portions, thereby scattering the outside gas in multiple directions and delaying an input time of the outside gas.

7. The display device provided with the gas input barrier as claimed in claim 1, wherein the first and second gas barrier layers comprise transparent or semi-transparent gas barrier film layers.

8. The display device provided with the gas input barrier as claimed in claim 1, wherein the second gas input barrier is compressed by another compression jig, and has a thickness less than the first gas input barrier.

9. A display device provided with a gas input barrier, comprising:
an upper substrate provided with a first adhesive layer;
a gas barrier layer provided with a second adhesive layer;
a first gas input barrier provided at a lateral side of the upper substrate and the gas barrier layer to encapsulate the upper substrate and the gas barrier layer through lamination, and to block input of outside gas; and
a second gas input barrier which is further compressed toward the gas barrier layer of the first gas input barrier using a compression jig, and which blocks an input path of the outside gas into the first gas input barrier.

10. The display device provided with the gas input barrier as claimed in claim 9, wherein the compression jig comprises an uneven jig.

11. The display device provided with the gas input barrier as claimed in claim 9, wherein the second gas input barrier comprises multiple uneven portions made by the uneven jig, the multiple uneven portions comprise multiple embossed projections, and the embossed projections are not aligned.

12. The display device provided with the gas input barrier as claimed in claim 9, wherein the second gas input barrier comprises any one of a curved line pattern, an oblique line pattern, a net pattern, and a zigzag pattern.

13. The display device provided with the gas input barrier as claimed in claim 9, wherein the second gas input barrier causes the outside gas input into the first gas input barrier to collide with uneven portions, thereby scattering the outside gas in multiple directions and delaying an input time of the outside gas.

14. The display device provided with the gas input barrier as claimed in claim 9, wherein the upper substrate comprises one of a glass substrate and a transparent substrate, and the gas barrier layer comprises one of a transparent and semi-transparent gas barrier film layer.

15. The display device provided with the gas input barrier as claimed in claim 9, wherein the second gas input barrier is compressed toward the gas barrier layer by another compression jig, and has a thickness less than the first gas input barrier.

16. A display device provided with a gas input barrier, comprising:
a lower substrate provided with a first adhesive layer;
a gas barrier layer provided with a second adhesive layer;
a first gas input barrier provided at a lateral side of the lower substrate and the gas barrier layer to encapsulate the lower substrate and the gas barrier layer through lamination, and to block input of outside gas; and
a second gas input barrier which is further compressed toward the gas barrier layer of the first gas input barrier using a compression jig, and which blocks an input path of the outside gas into the first gas input barrier.

17. The display device provided with the gas input barrier as claimed in claim 16, wherein the compression jig comprises an uneven jig.

18. The display device provided with the gas input barrier as claimed in claim 16, wherein the second gas input barrier comprises multiple uneven portions made by the uneven jig, the multiple uneven portions comprise multiple embossed projections, and the embossed projections are not aligned.

19. The display device provided with the gas input barrier as claimed in claim 16, wherein the second gas input barrier comprises any one of a curved line pattern, an oblique line pattern, a net pattern, and a zigzag pattern.

20. The display device provided with the gas input barrier as claimed in claim 16, wherein the second gas input barrier causes the outside gas input into the first gas input barrier to collide with uneven portions, thereby scattering the outside gas in multiple directions and delaying an input time of the outside gas.

21. The display device provided with the gas input barrier as claimed in claim 16, wherein the lower substrate comprises one of a glass substrate and a lower electrode substrate, and the gas barrier layer comprises one of a transparent and semi-transparent gas barrier film layer.

22. The display device provided with the gas input barrier as claimed in claim 16, wherein the second gas input barrier is compressed toward the gas barrier layer by another compression jig, and has a thickness less than the first gas input barrier.
